(19) United States
(12) Patent Application Publication
(10) Pub. No.: US 2011/0007923 A1
(43) Pub. Date: Jan. 13, 2011

(54) Loudspeaker cabinet and reproduction system

(75) Inventors: Hubert Kalkman, Breda (NL); Adrianus Petrus Johannes Weijtmans, Tilburg (NL); Lljawitsh lvanowitsj Stanislav Vermeulen, Tilburg (NL)

Correspondence Address: HOFFMANN & BARON, LLP, 6900 JERICHO TURNPIKE, SYOSSET, NY, 11791, US

(73) Assignee: Van Der Putt & Partners B.V., Breda (NL)

(21) Appl. No.: 11/666,035

(22) PCT Filed: Oct. 20, 2005
(86) PCT No.: PCT/NL2005/000756

§ 371 Date: Dec. 1, 2008

(30) Foreign Application Priority Data
Oct. 20, 2004 (NL) 1027302

(51) Int. Cl. H04R 1/20; H04R 1/02

(52) U.S. Cl. 381/353; 381/345

(57) ABSTRACT

A loudspeaker box comprising a first and a second speaker unit each adjacent a sound space formed in the housing. The loudspeaker box further comprises a separation element provided between the sound spaces. The separation element comprises faces to reflect at least a part of sound waves to be radiated by a backside of the speaker units into the sound spaces. As well, the separation element leaves open a passage between the sound spaces. By reflection of sound waves at the faces of the separation element an acoustic influence on the speaker units occurs as a result of which for example an electric filtering of signals being supplied to the speaker units can be dispensed with. In a further aspect of the invention, the loudspeaker box comprises a further compartment that is at least partially filled with a granular material.

The invention relates to a loudspeaker box comprising a housing, a first speaker unit adjacent to a first sound space formed in the housing, and a second speaker unit adjacent to a second sound space formed in the housing. The invention also relates to a reproduction system comprising such a loudspeaker box.

For many years, loudspeaker boxes for the reproduction of a sound signal and the conversion of an electric signal into an acoustic signal are being manufactured in many varieties. Already many attempts have been made to design a loudspeaker box that provides a reproduction true to nature of a sound signal representing a sound recording. From a large variety of solutions that are known and aim at a correct reproduction of the sound, a few are mentioned below.

A well-known solution is the use of electric filters for separating the sound signal supplied to the loudspeaker box in components each having a separate frequency band. Each of these components is conducted to a separate speaker unit for reproduction thereof. Although in this solution a frequency range to be reproduced by the loudspeaker box can be increased, a disadvantage is that the electric filters, comprising for example inductors, capacitors and the like, introduce undesirable side effects, such as the occurrence of phase shifts, settling phenomena at suddenly occurring sound signals, etc.

A second known solution is to create a very solid, rigid housing to thereby dampen resonances occurring in the housing. Besides the use of thick walls for the housing, also solutions are known such as manufacturing the wall from a natural stone or a composition in which a type of stone, a concrete or a sand has been incorporated. With such measures one aims to prevent resonances to occur in the housing, as a result of which objectionable side effects that would disturb a reproduction should be suppressed. However, a disadvantage of such a solution is that a sound image to be perceived by a listener will lack spaciousness and openness as a result of the rigid housing. A high rigidity of the housing causes an effect to occur that the listener will judge the sound as if coming from a box instead of that a spatial sound image will be created for the listener.

A third known solution is to apply a large number of loudspeaker boxes that are set up at different places in a listening space to create a spatial reproduction. In many cases an amplifier is used with as many channels as there are loudspeaker boxes in such a situation. At present, such systems are on the market having for example five loudspeaker boxes or seven loudspeaker boxes, and they are usually referred to as surround or surround sound or a similar term. A disadvantage of such a solution is that many users are less content with the large quantity of equipment and wiring which must be provided in the listening space. Also, the envisaged spaciousness of the sound reproduction appears to occur only when a sound signal of a corresponding sound source is being played, in other words a sound signal that also has a large number of channels, for example four or five channels. A lot of contemporary sound sources such as radio, television and compact discs, however, only provide two channels, so that the spaciousness envisaged with this solution will not be realized in this way.

In general terms, it appears that in fact all solutions known so far introduce an undesirable side effect, so that each known solution is a compromise. As described above, side effects are introduced by the application of electric filters, stiffening the housing also appears to lead to undesirable side effects, and in most of the situations the use of a large number of loudspeaker boxes distributed all around in a listening space also does not lead to a satisfactory solution in the opinion of many users.

An object of the invention is to provide a loudspeaker box that provides a spatial reproduction which is true to nature.

To reach this object, the loudspeaker box according to the invention is characterized in that the loudspeaker box further comprises a separation element provided between the first and the second sound spaces, the separation element comprising a first face for reflecting into the first sound space at least a part of sound waves to be radiated by a backside of the first speaker unit and a second face for reflecting into the second sound space at least a part of sound waves radiated by a backside of the second speaker unit, wherein the separation element leaves open a passage between the first and the second sound spaces. The inventors realized that an acoustic influence on the speaker units in the loudspeaker box occurs by the use of the separation element. By such an acoustic influence it is possible to avoid the use of electric filters. Also, it is possible to prevent distortion. A part of the sound waves radiated by the backside of the speaker units will be reflected by the first and the second face, respectively, of the separation element and thereby enter said sound space. By varying parameters at the face, such as a roughness, an angle, a possible sloping or bulging thereof, etc., an acoustic influence on said speaker unit will occur. Through the passage left open by the separation element between the first and the second sound spaces, a certain degree of acoustic influence between the first and the second speaker units can be realized. The inventors have found that the occurrence of distortion can be suppressed extensively through such an influence. The inventors have aimed at connecting the sound spaces with each other by means of the passage in a way that reminds of communicating vessels and in this way provide more stability to the speaker units as a result of which they behave more restful in operation and therewith improve a clarity and rest of the sound image to be created by the loudspeaker box. In a preferred embodiment the first and the second sound spaces have a volume different from each other, wherein preferably the angles of the faces of the separation element relative to a front wall of the first and the second sound spaces are different, and are chosen in such a way that sound waves radiated by a backside of the first and the second speaker unit, respectively, are reflected at least partially into the sound space concerned by the first and the second face, respectively. The inventors have found that by such an acoustic influence on the speaker units, the speaker unit having a smaller sound space and an angle of the separation element adjusted thereto proportionally will reproduce more high tones, while the speaker unit having a larger sound space and the associated angle chosen of the face concerned of the separation element will reproduce relatively mare low tones. As a result of the different sizes of the sound spaces a pressure difference will arise between them in operation. Now, by providing a passage between the sound spaces according to the invention, a leveling of pressure can be brought about, and associated with it a certain acoustic influence between the speaker units can be brought about. Thus, a device is created by the loudspeaker box according to the invention, wherein the speaker units influence each other mutually through the passage, and wherein an influence of the sound waves to be radiated by said speaker unit at the backsides occurs by the separation element, and wherein an influence occurs between the speaker units mutually through the passage. By means of such an acoustic influence an electric filtering accompanied by the many negative effects can be avoided. The inventors realized that by the use of an electric filter, non-linearities and other undesirable mutual influences between the speaker units will arise.

In a loudspeaker box with an electric filter according to the prior art, the speaker units are connected to a filter after all, wherein the speaker units influence an impedance characteristic of the electric filter by means of impedance modulation, microfonics and other effects and thereby also provide electric mutual influence through the filter between the speaker units. Such an influence leads to many undesirable effects, among which phase shifts, impedance changes, nonlinear phenomena, etc. While according to the prior art the different speaker units (which usually each provide for a reproduction of a separate frequency range) each are accommodated in a separate compartment of the loudspeaker box, so each having a sound space entirely of its own, to therewith prevent a mutual influence between the speaker units according to the prior art, the inventors have established that the opposite is the case with this conventional solution: although a direct acoustic influence is suppressed by means of separating the resonance boxes of the separate speaker units, precisely the fact that the speaker units are all connected to the filter creates a large amount of influence between the speaker units which, as found by the inventors, will lead to a degradation of the sound reproduction.

In a further preferred embodiment of the invention the housing comprises a further compartment that is at least partially filled with a granular material (also indicated as loosely granular material). The inventors have found that the measure used to suppress vibrations according to the prior art, namely the use of a rigid box, so for example a box comprising thick walls, leads to an undesirable “narrowing” of a sound image to be radiated by a speaker, in other words the effect occurs that the speaker will sound as if the sound comes from a box, instead of a spatial sound effect being created. Now, by providing a housing having a further compartment in which a granular material is provided according to the invention, resonances can be suppressed. In operation, the vibrations generated in the loudspeaker box that can lead to a resonance will initiate a vibration of the granular material in the further compartment. Because of the granular nature of the material a moving of the grains with respect to each other occurs through influence of vibrations, which leads to a friction between the grains, and therewith to a generation of heat. Thus, since vibration energy is converted into heat, an effective damping of the vibrations occurs. As a result thereof resonances (which in general are undesirable) are damped by the granular material. This renders the possibility to use a housing that is relatively thin (that is, compared to the prior art), since undesirable resonances are damped by the granular material so that for suppressing resonances a high rigidity can be avoided. Several advantages are gained by the loudspeaker box according to this aspect of the invention: first, it appears that a very spatial reproduction can be created because a housing having walls with a high rigidity according to the prior art can be dispensed with. By the loudspeaker box according to this aspect of the invention a spatial reproduction can be created, the sound as perceived by the listener being located in the listening space in which the speakers are arranged, without occurrence of the effect of the sound coming from a box, which effect occurs to a certain degree in a loudspeaker box according to the prior art. From listening tests this appears to be a very important parameter for reaching a reproduction considered as natural by a listener, since of course the original sound source represented by the recording in general is no sound source from a rigid box or other enclosure. A second positive effect occurring in a loudspeaker box according to this aspect of the invention is a spatial radiation of sound waves from the loudspeaker box. In contrast to the prior art in which the loudspeaker box appears to radiate particularly to a front side, with the loudspeaker box according to this aspect of the invention a spatial radiation occurs under a wide angle so that a listener located right in front of a center between two loudspeaker boxes can not only enjoy a stereo and/or spatial effect, moreover, it appears that by the spatial radiation behaviour of the loudspeaker box such an effect can be perceived that is highly independent of a position of the listener in the listening space. Yet another effect occurring in the loudspeaker box according to this aspect of the invention is that the suppression of undesirable resonances by means of the granular material leads to a stationary part of the speaker unit being stable. By a stable position of the stationary part of the speaker unit undesirable movements of the speaker unit as well as non-linearities and distortions caused thereby are prevented. It has to be kept in mind that a movement of the stationary part of the speaker unit (in which in general a magnet is included) leads to undesirable effects such as non-linearities, or other distortions. In the loudspeaker box according to this aspect of the invention a very pure and restful reproduction is reached since resonances of the housing are damped by the compartment containing the granular material so that the stationary part of the speaker unit remains still also at a high volume and undesirable resonances thereof are suppressed.

In the above described preferred embodiment of the loudspeaker box according to the invention, both the separation element described above with a passage between the first and the second sound space, and the further compartment containing the granular material are provided. However, the further compartment can also be applied to every other loudspeaker box (so also to any loudspeaker box according to the prior art having for example a single speaker unit, or for example having several speaker units controllable through an electric or electronic separation filter). The above described effects of the compartment filled with a granular material occur in each loudspeaker box to a certain degree. However, the inventors have found that a combination of both measures—i.e. the separation element and the compartment containing granular material—leads to a highly advantageous embodiment. Namely, by applying the compartment containing the granular material, vibrations are suppressed so that also the separation element is highly protected from undesirable vibrations and resonances which prevents disadvantageous effects on the acoustic influence brought about by the separation element. For example, the granular material can comprise a sand, such as a shell sand and/or an oyster grit. In general, a use of each granular material is conceivable, a finely grained material being preferred since a better damping of vibrations, and in particular resonances, is reached therewith.

Preferably, the speaker unit comprises a speaker unit having a movable coil and a fixed magnet, however, also other speaker units are conceivable such as an electrostatic speaker unit, a piezo-electric speaker unit, etc. In this document, the term adjacent to, in the context of the speaker unit being adjacent to a sound space, must be understood as each form of being adjacent to, the speaker unit can be incorporated in a wall of the sound space, however, it is also possible for the speaker unit to be located entirely or partially in said sound space. Within the framework of this document the term reflecting must be understood as both a targeted reflecting and a diffuse reflecting, in other words the diffusion of sound waves under a wide angle. The terms front side and backside, respectively, of a sound space must be understood as the side to which the speaker unit is adjacent and the side which faces away from the speaker unit, respectively. In general, an assembly of sound spaces of the loudspeaker box, in other words the whole sound space constituted by the first and the second sound space (and possibly further sound spaces) is closed, however, it is also possible for this whole sound space to comprise an open connection, such as for example a bass reflex gate.

Further embodiments, variants and advantages of the invention will become clear from the appended drawings, wherein a non-limiting exemplary embodiment is shown, in which:

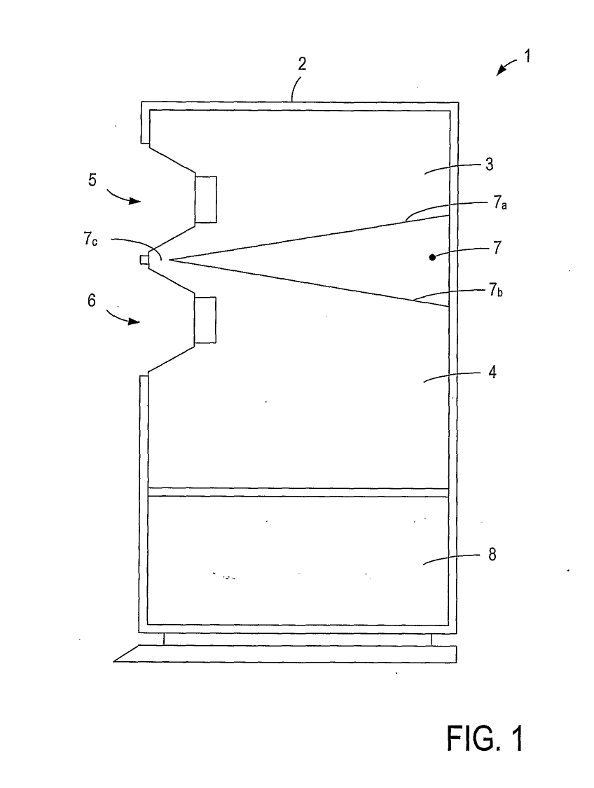

FIG. 1 shows a schematic cross-sectional view of a loudspeaker box according to the invention;

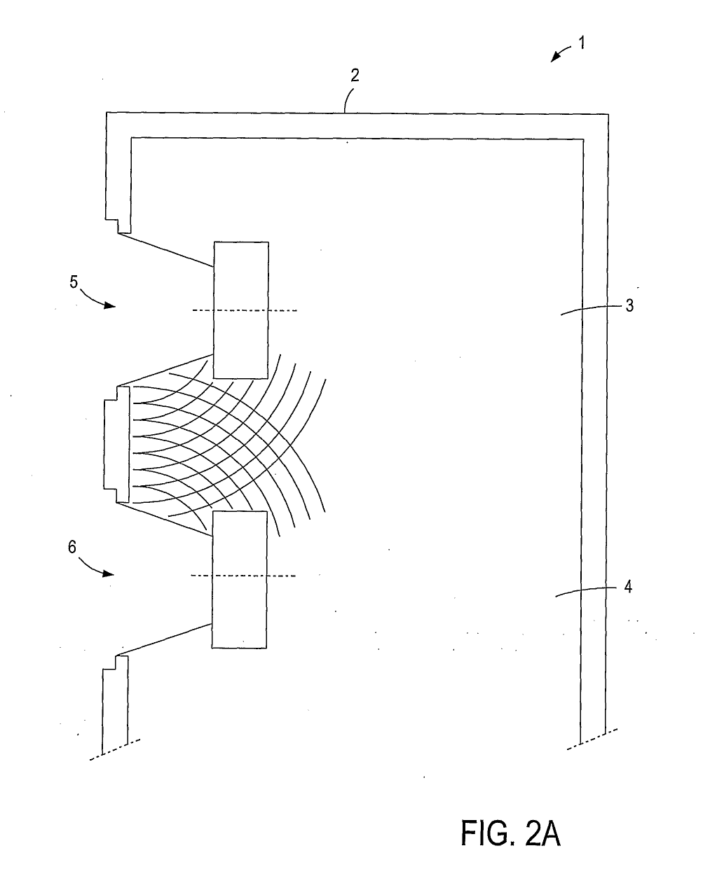

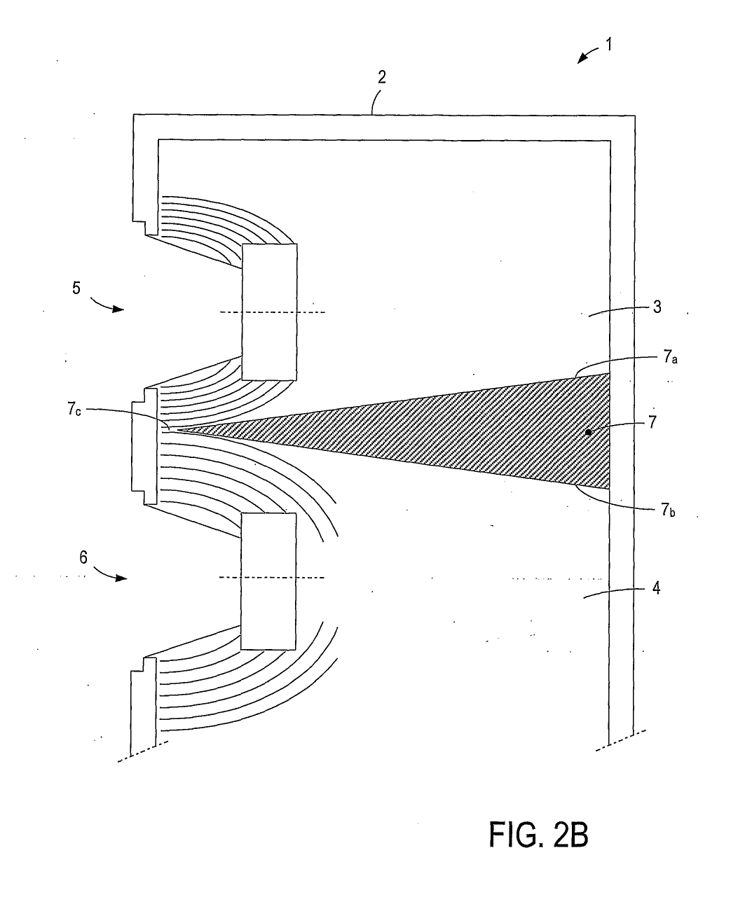

FIGS. 2a and 2b show a loudspeaker box without and with a separation element, respectively, wherein an effect of the separation element is described according to a pattern of sound waves; and

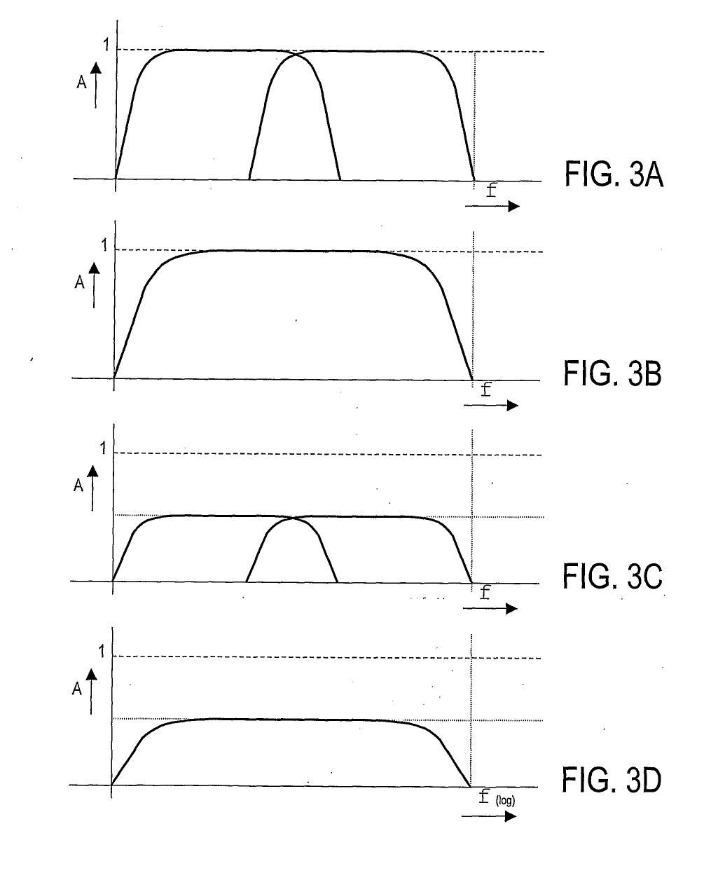

FIGS. 3a-3d show very schematic frequency diagrams of different loudspeaker boxes with and without a separation element, respectively, and a compartment containing granular material.

FIG. 1 shows a loudspeaker box 1 comprising a housing 2, a first sound space 3, and a second sound space 4. A first speaker unit 5 is adjacent to the first sound space 3. A second speaker unit 6 is adjacent to the second sound space 4. Between the first sound space 3 and the second sound space 4 a separation element 7 is provided. The separation element 7 comprises a first face 7a and a second face 7b. Between the first sound space 3 and the second sound space 4 a passage 7c is situated that in this exemplary embodiment is located at the front side of the loudspeaker box, in other words in this exemplary embodiment at a side where the speaker units 5, 6 are provided. The loudspeaker box 1 further comprises a compartment 8 filled with granular material, in this exemplary embodiment a mixture of shell sand and oyster grit. Now, an operation of the loudspeaker box according to FIG. 1 will be explained by means of FIG. 2a and FIG. 2b.

FIG. 2a shows a loudspeaker box not having a separation element and FIG. 2b shows a loudspeaker box having a separation element according to the invention. The same reference numerals in FIGS. 2a and 2b refer to the same or similar elements as in FIG. 1. In FIG. 2a both speaker units 5 and 6 operate in a same closed space and therewith send sound waves to each other that lead to a disturbed environment for each other. Sound waves radiated by a backside of the first speaker unit 5 reach a backside of speaker unit 6 and lead to a disturbance of speaker unit 6, and vice versa. In FIG. 2b the sound waves radiated from a backside of the first speaker unit 5 will hit at the first face 7a of the separation element 7 will hit and as a result are reflected at least partially. Likewise, sound waves radiated by a backside of the second speaker unit 6 will be reflected by the second face 7b of the separation element 7. In this way, a mutual influence of the speakers such as occurring in the loudspeaker box according to FIG. 2a is avoided. Since the first speaker unit 5 is adjacent to a sound space 3 smaller than the second speaker unit 6, the first speaker unit 5 will generate more high tones in proportion, in other words will behave more like a high tones speaker. The second speaker unit 6 adjacent to the larger sound space 4 will behave more like a low tones speaker in proportion because of this larger sound space, in other words will produce more lower tones. An overpressure generated by the first speaker unit 5 in the smaller sound space 3 may escape at least partially through the passage 7c of the first sound space 3 to the second sound space 4.

Preferably, the speaker units 5 and 6 are broadband speakers that preferably are serial linked electrically. Preferably, the separation element 7 is fixed to a back wall of the first sound space 3 and the second sound space 4, so that on the one hand a firm, in other words low vibration fixing of the separation element 7 is reached, and on the other hand a passage at or near a front wall of the sound space can be realized. An advantage of providing the passage 7c at the front wall or the front side of the sound space 3, 4 is that this location constitutes a relatively “restful” part of the sound space, in other words an area in the sound space where a relatively low sound pressure prevails. In addition, the dimensions of the passage 7c have been chosen in such a way, that on the one hand a sufficiently large leveling of pressure between the first sound space 3 and the second sound space 4 may occur, while on the other hand a large part of the sound waves to be radiated by the backsides of the first speaker unit 5 and the second speaker unit 6 at the respective faces 7a, 7b of the separation element 7 are reflected or echoed. In a preferred embodiment the separation element is wedge-shaped so that on the one hand a very stable fixing to e.g. the back wall of the sound spaces 3, 4 can be reached, while on the other hand the faces 7a, 7b can be arranged under an suitable angle relative to the backside of the speaker units. Due to the fact that the sound space 3 has a different size than the sound space 4, an angle of the face 7a relative to a back wall or front wall of the housing 2 in this exemplary embodiment is unequal to an angle of the second face 7b relative to the front wall or back wall of the housing 2, so that therefore the separation element in a cross-section thereof comprises a non-equilateral triangle. An advantage thereof is that the face 7a respectively 7b can be placed under an angle adjusted to the dimensions of the respective sound spaces with which said face of the separation element cooperates. Since the sound space 4 is larger than the sound space 3, in a preferred embodiment the face 7b will be more slanting, in other words will reflect sound waves to be radiated by the backside of the speaker more in a vertical direction, in other words more into the deeper sound space 4 than will be the case with the first sound space 3 and the corresponding face 7a. In an advantageous embodiment a first angle between the first face of the separation element and a front wall of the first sound space is 68 degrees (more in general, preferably between 50 and 80 degrees), and a second angle between the second face of the separation element and a front wall of the second sound space between 50 and 80 degrees, preferably 63 degrees. As explained above, a reason for creating a different angle of the first face and the second face with respect to a back wall of the sound spaces in a preferred embodiment lies in the fact that the sound spaces have a volume different from each other in a preferred embodiment. For reaching a desired acoustic influence of the speaker units, a ratio between a volume of the first sound space and a volume of the second sound space preferably is equal to 1:2. Of course, also other ratios are possible depending on a desired degree of acoustic influence, however, in general the ratios will be between 1:5 and 1:1.25. As described here, the second sound space is larger than the first one, however, of course it can also be the other way round. In a practical embodiment such a difference in volume is realized by means of a difference in height between the first and the second sound space, in other words, as is shown also in FIG. 1, both sound spaces have an equal width and depth whereas they differ in height. In such an embodiment, the chosen volume difference combined with a first angle of 68° and a second angle of 63° appears to provide an advantageous acoustic effect that leads to an open, restful and undistorted sound image, wherein the first speaker unit 5 shows an inclination to behave more like a medium/high tones speaker while the second speaker unit 6 shows an inclination to behave more like a medium/low tones speaker. Thus, it has appeared that high tones are reproduced in particular by the first speaker unit 5 while low tones are reproduced in particular by the second speaker unit, while both speaker units 5, 6 are equal to each other and are preferably serially linked in this preferred embodiment.

The separation element can be manufactured from a large number of materials, wherein a wood, preferably a long vein wood type such as oak or teak is preferred. Preferably, the separation element is manufactured from a material showing a sufficient degree of rigidity to minimize a noteworthy distortion thereof by sound waves to be radiated by the speaker units, while on the other hand a certain elasticity of the material from which the separation element is manufactured is desirable to prevent a bouncing off of sound waves thereon, and a “hardness” of a sound image to be perceived by a listener caused thereby. Preferably, the first and second face are roughened, in other words are not extremely smooth or polished, so that a certain diffuse reflection of sound waves to be radiated by the backsides of the speaker units occurs, as a result of which a more pleasant sound image is created for the listener. Furthermore, it appeared that, when the separation element is manufactured out of a wood, preferably a vein of the wood should pass the sound spaces substantially transversely to the front wall to realize a desired degree of diffuse reflection of sound waves at the first and second face. As well, the direction of the vein of the wood in the separation element chosen in this way leads to a desired elasticity of the separation element that positively affects the sound image to be reproduced by the speaker. The faces of the separation element can be flat or show each desirable bulging or curving, such as for example a convex or concave bulging or curving for a desired reflection characteristic and an acoustic influence related thereto.

As shown in FIG. 1, the passage between the first and the second sound space preferably is provided at a side of the sound space facing the front wall. Namely, in operation it appeared that in this place in the sound spaces a relatively restful sound image occurred, so that at this place a passage brings about a relatively small direct influence between the first and the second speaker unit. A desirable pressure leveling does occur by the passage such as described above. Since in a preferred embodiment the separation element is attached to the back wall of the sound spaces, and a certain degree of flexibility of the separation element is desirable, preferably, the separation element is kept free from sidewalls of the sound spaces, in other words the passage between the first and second sound spaces preferably comprises a passage at a side of the sound space facing a sidewall. In a preferred embodiment, such a passage has small dimensions, preferably between 2 and 4 mm between the separation element and the sidewall or between the sidewall and damping material provided on the sidewall.

As described above, the loudspeaker box 1 comprises a further compartment 8 in which a granular material is provided. Preferably, the granular material comprises a sand, such as a shell sand and/or an oyster grit, however, also many other materials can be used, such as glass grains or glass beads, polyester grains, etc., a granular material comprising grains having rough surfaces being preferred since a higher damping of vibrations is reached by the roughness of the grains. In a preferred embodiment, at least one of the front wall 2a, back wall 2b and sidewall (not shown) of the first and/or second sound spaces 3, 4 and a corresponding wall of the compartment is manufactured from one piece. An advantage thereof is that the wall concerned shows a lower acoustic impedance since it is manufactured from one piece, so that a lower acoustic impedance is created between the part of the loudspeaker box where vibrations are generated (the area of the loudspeaker box where the speaker units and the sound spaces are located), and the compartment 8 where, on the contrary, vibrations are damped as a result of the vibrations setting the grains of the granular material in motion. By the low acoustic impedance thus reached, a correct transfer of vibrations from the part of the loudspeaker box where vibrations are generated to the part of the loudspeaker box where vibrations are damped occurs, so that an effective damping of undesired resonances can be realized. To further reduce an impedance between the part where vibrations are generated and the part where vibrations are damped, one or more of the walls of the compartment can be provided with bulges or dents, for example ribs. The granular material, at least an outline thereof, follows the bulges or dents in said wall or walls, leading to an increase of a contact surface between said wall and the granular material, which provides for an improved transfer of vibrations from the wall to the granular material and thus a reduced impedance and as a consequence an improved damping of vibrations.

As described above, the presence of the compartment 8 with the granular material contained therein leads to a damping of vibrations and in particular resonances, which makes a rigid housing of the loudspeaker box, and a corresponding large wall thickness thereof, as this is applied in the prior art to suppress resonances, redundant. Preferably, then also the sidewall and back wall of the sound spaces are thin, preferably thinner than 18 mm, more preferably 12 mm. Such a wall thickness of 12 mm in conjunction with a compartment 8 containing an amount of shell sand and/or oyster grit weighing 1 kg appears to lead to an adequate damping of vibrations. Besides, a much more spatial sound reproduction appears to occur due to the thin-walled housing than could have been realized by a housing having a larger wall thickness according to the prior art. Preferably, the compartment is arranged in a bottom part of the housing to therewith also reach an acoustic decoupling between the speaker unit and a basis on which the speaker is placed. Also, it is conceivable for the compartment to comprise a compartment in an upper part of the housing, allowing a further damping to be reached. When for example the speaker units as shown in FIG. 1 are provided mainly in an upper part of the housing, then a presence of a compartment filled with granular material at an upper part of the housing will lead to a further damping of vibrations due to the extremely low impedance between the location where vibrations are generated and said compartment which is located in an upper part of the housing.

For an effective damping, the volume of the compartment preferably is between 5% and 25%, more preferably 10% of a total volume of a sound space present in the housing. Also, there appears to be an advantageous effect when a solid substance further is provided in the compartment, preferably having a high specific weight, such as lead, since in this way a further damping appears to be reached.

Effective dimensions of the housing in practice appear to be for example a height of 44 cm, a width of 14 cm and a depth of 15.3 cm when using speaker units having a diameter of 11.5 cm.

At the back wall of the sound spaces a damping material comprising a foam material is provided. Such a damping material can also be applied to an upper wall of the first sound space and to a bottom wall of the second sound space. Preferably, a damping material comprising a lead bitumen is applied to the sidewalls of the sound spaces. From listening tests, such a choice of damping materials combined with the separation element and the compartment containing granular material appeared to lead to an extremely lively, open sound image. Also, it appeared to be advantageous when at least a part of a side of the front wall facing the sound spaces is not provided with a damping material. This seems to relate to the fact that a large part of the vibrations and resonances to be generated by the speaker units are lead to the compartment via a front wall of the sound spaces. Now, when the front wall at least partially is not covered by a damping material, then a very low acoustic impedance is created along a path running from the sound spaces and the speaker units via the front wall of the sound spaces to the compartment. To further enlarge this effect it is preferred to manufacture a front wall of the sound spaces from a material somewhat thicker than a material from which the sidewall and back wall of the sound spaces are manufactured. In the advantageous embodiment described above, in which the sidewall and back walls of the sound spaces are manufactured from a material having a 12 mm thickness, an advantageous choice for the front wall of the sound space appears to be a thickness of 20 mm.

An effect of the compartment containing granular material and an effect of the separation element on a frequency characteristic of the speaker unit as shown in FIG. 1 are shown with reference to FIGS. 3a-3d. Along a horizontal axis of the FIGS. 3a-3d a frequency is shown repeatedly at a logarithmic scale. Along a vertical axis an amplitude is shown, also at a logarithmic scale. In FIG. 3d a frequency characteristic of a loudspeaker box according to the prior art is shown. In the chosen exemplary embodiment, the speaker units 5, 6 are broadband speakers, which leads to the relatively flat frequency characteristic as shown in FIG. 3d. Next, the separation element is added to the loudspeaker box as is described by means of FIG. 1, then both the speaker units 5, 6 will show a frequency behaviour different from each other. The first speaker unit 5 will behave more like a high-frequency speaker unit and the second speaker unit 6 will behave more like a low-frequency speaker unit, and in this way the frequency characteristic shown in FIG. 3c having two curves different from each other for the separate speaker units arises. In FIG. 3b a frequency curve of a loudspeaker box according to the invention is shown, providing a compartment containing granular material in a way as shown in FIG. 1, however, no separation element being arranged. The acoustic influence realized by the separation element, as shown in FIG. 3c thus does not occur in the situation described in conjunction with FIG. 3b, however, an improvement of an efficiency of the loudspeaker box, as found by the inventors, will occur as a result of presence of the compartment containing granular material. An explanation for such an improvement of efficiency seems to lie in the associated possibility for thinning of walls of the sound space, as well as in the fact that an improved operation of the speaker units occurs which leads to a larger acoustic output by the extremely low vibration arranging of the speakers, as reached by presence of the compartment containing granular material. When the measures as shown separately by means of FIGS. 3b and 3c are combined with each other, in other words in the situation of the loudspeaker box as described by means of FIG. 1, a frequency characteristic occurs as shown in FIG. 3a, in other words both an increase of an efficiency of the loudspeaker box as described by means of FIG. 3b will occur and an acoustic influence which leads to a different frequency characteristic of the speaker units 5, 6 in the chosen exemplary embodiment, in other words to the frequency characteristic as shown in FIG. 3a.

Besides the described embodiments, many varieties are conceivable. For example, the speaker units can comprise a low-frequency speaker unit, a medium-frequency speaker unit and/or a high-frequency speaker unit; one, two, three or more speaker units can be provided in the housing, these speaker units being either equal to each other or different from each other, for example because of having other dimensions, or having a frequency characteristic different from each other; the housing can have numerous shapes, etc.

The loudspeaker box according to the invention can comprise a separate, movable loudspeaker box, however, it is also possible for the loudspeaker box to be incorporated in a reproduction system, for example a sound reproduction system such as a stereo installation, a sound blaster, a vehicle audio system, a sound reproduction system in conjunction with a computer, etc., however, it is also possible for the reproduction system to comprise a joined image-sound reproduction system such as for example a television set, a screen containing integrated or associated speaker boxes, a portable so-called laptop or notebook computer, etc. In particular, the loudspeaker box according to the invention appears to provide extremely good results in a two-channel so-called stereo sound system, for example as a stereo sound system or combined with a screen for reproducing audiovisual information, wherein a use of a multi-channel system, for example five-channel or seven-channel system has become redundant because of the spatial and natural reproduction of the sound image reached with the loudspeaker box.

1. Loudspeaker box, comprising:
a housing,
a first speaker unit adjacent to a first sound space formed in the housing, and
a second speaker unit adjacent to a second sound space formed in the housing,
wherein the loudspeaker box further comprises a separation element provided between the first and the second sound spaces, the separation element comprising a first face for reflecting into the first sound space at least a part of sound waves to be radiated by a backside of the first speaker unit, and a second face for reflecting into the second sound space at least a part of sound waves to be radiated by a backside of the second speaker unit, the separation element leaving open a passage between the first and the second sound spaces.

2. The loudspeaker box according to claim 1, wherein the separation element is fixed to a back wall of the first and second sound spaces.

3. The loudspeaker box according to claim 1, wherein the separation element is wedge-shaped.

4. The loudspeaker box according to claim 3, wherein the separation element in a cross-section thereof comprises a non-equilateral triangle.

5. The loudspeaker box according to claim 3, wherein a first angle between the first face of the separation element and a front wall of the first sound space is between 50 and 80 degrees, preferably 68 degrees.

6. The loudspeaker box according to claim 5, wherein a second angle between the second face of the separation element and a front wall of the second sound space is between 50 and 80 degrees, preferably 63 degrees.

7. The loudspeaker box according to claim 1, wherein the first sound space and the second sound space have a volume different from each other, wherein a volume ratio between the sound spaces preferably is between 1:1.25 and 1:5, more preferably 1:2.

8. The loudspeaker box according to claim 1, wherein the first and the second face are roughened.

9. The loudspeaker box according to claim 1, wherein the separation element comprises a wood, preferably of a long-vein wood type, such as oak or teak.

10. The loudspeaker box according to claim 9, wherein a vein of the wood in the separation element runs substantially transversely to the front wall of the sound spaces.

11. The loudspeaker box according to claim 1, wherein the passage between the first and second sound spaces comprises a passage at a side of the sound spaces facing the front wall.

12. The loudspeaker box according to claim 1, wherein the passage between the first and second sound spaces comprises a passage at a side of the sound space facing a sidewall.

13. The loudspeaker box according to claim 1, wherein the speaker units are serially linked.

14. The loudspeaker box according to claim 1, wherein the housing comprises a further compartment which is at least partially filled with a granular material.

15. The loudspeaker box according to claim 14, wherein at least one of the front wall, sidewall and back wall of the first sound space and a corresponding wall of the compartment are manufactured in one piece.

16. The loudspeaker box according to claim 14, wherein one or more walls of the compartment have been provided with bulges or dents, such as ribs, an outline of the granular material following the dents or bulges.

17. The loudspeaker box according to claim 14, wherein the sidewalls and back wall of the sound spaces are thin, preferably thinner than 18 mm, more preferably 12 mm.

18. The loudspeaker box according to any of claim 14, wherein the granular material comprises a sand, preferably a shell sand and/or an oyster grit.

19. The loudspeaker box according to claim 14, wherein the compartment comprises a compartment in a bottom part of the housing.

20. The loudspeaker box according to claim 14, wherein the compartment comprises a compartment in an upper part of the housing.

21. The loudspeaker box according to claim 14, wherein a volume of the compartment is between 5% and 25%, preferably 10% of a total volume of sound spaces present in the housing.

22. The loudspeaker box according to claim 14, wherein further a damping mass from a solid substance, preferably lead, is provided in the compartment.

23. The loudspeaker box according to claim 1, wherein a damping material comprising a foam material is provided at the back wall of the sound spaces.

24. The loudspeaker box according to claim 1, wherein a damping material comprising a lead bitumen is provided at the sidewall of the sound spaces.

25. The loudspeaker box according to claim 1, wherein at least part of a side of the front wall facing the sound spaces is not provided with a damping material.
